(19) United States
(12) Patent Application Publication
(10) Pub. No.: US 2023/0142525 A1
(43) Pub. Date: May 11, 2023

(54) INFORMATION PROCESSING APPARATUS, INFORMATION PROCESSING METHOD, AND PROGRAM

(71) Applicant: Nippon Telegraph and Telephone Corporation, Tokyo (JP)

(72) Inventors: Aiko OI, Musashino-shi, Tokyo (JP); Ryosuke SATO, Musashino-shi, Tokyo (JP); Motomu NAKAJIMA, Musashino-shi, Tokyo (JP)

(21) Appl. No.: 17/917,644

(22) PCT Filed: Apr. 7, 2020
(86) PCT No.: PCT/JP2020/015629

§ 371 Date: Oct. 7, 2022

(51) Int. Cl. G06Q 10/0633

(52) U.S. Cl. CPC G06Q 10/0633

(57) ABSTRACT

An information processing device 1 according to an embodiment of the invention includes scenario definition information 17 which holds a scenario including a combination of steps in a workflow expressed using multiple kinds of general tasks, general task definition information 18 which holds an external definition file which defines processing in each of the steps, a general task executing unit 14 which executes a step according to an external definition file corresponding to the step, and a scenario executing unit 13 which selects a scenario corresponding to a received failure alarm and causes the general task executing unit 14 to execute each of the steps according to the scenario.

### TECHNICAL FIELD

The present invention relates to an information processing device, an information processing method, and a program for work automation.

### BACKGROUND ART

Recently, efforts for automation have been active in order to improve work efficiency. For example, in the communication industry, many efforts have been made to introduce and operate commercially available workflow engines for the purpose of automating troubleshooting work in communication networks.

### CITATION LIST

### [Non Patent Literature]

[NPL 1] “StackStorm Overview” [online], retrieved from the Internet: <URL: https://docs.stackstorm.com/overview.html>

### SUMMARY OF THE INVENTION

### [Technical Problem]

In order to automate work using a commercially available product such as a workflow engine, the target workflow must be expressed as a configuration file or a scenario for the product. It may be easy to express a workflow in the way if the workflow has a small number of branches and its processing is executed in series, but it is difficult to express the entire workflow in a configuration file or a scenario if the workflow has many branches and requires execution of multiple kinds of parallel processing and comprehensive determination on the basis of multiple processing results. Scratch development using programming languages can be used to express the latter complex workflow, but it requires programming skills and tends to have a high degree of dependency on the program developer, which may give rise to a problem in terms of maintenance and management.

In troubleshooting work in a communication network, various actions (such as remote resetting of the device with the failure and on-site repair work) related to the troubleshooting must be accountable in terms of what to base for determinations on the content and timing of the actions. Therefore, the maintenance and operation department does not immediately take action when a failure occurs, but collects and analyzes information in many aspects, such as the state of the device, the state of ongoing construction, and the state of service at related departments before making a determination on the content and timing of action. Since multiple pieces of information are collected and a comprehensive determination is made accordingly, the troubleshooting workflow tends to be a complex flow with many steps and conditional branches.

A workflow cannot be easily produced for work expressed as a complex processing flow.

With the foregoing in view, it is an object of the present invention to allow a workflow for automation to be easily produced.

### [Means for Solving the Problem]

An information processing device according to one aspect of the present invention is a device for executing a workflow and includes a scenario holding unit which holds a scenario including a combination of steps in the workflow expressed using multiple kinds of general tasks, a definition information holding unit which holes definition information which defines processing in each of the steps, a task executing unit which executes the step according to the definition information corresponding to the step, and a scenario executing unit which selects the scenario corresponding to a generated event and causes the task executing unit to execute the steps according to the scenario.

An information processing method according to one aspect of the present invention is a method for executing a workflow and causes a computer to carry out the steps of holding a scenario including a combination of steps in the workflow expressed using multiple of kinds of general tasks, holding definition information which defines processing in each of the steps, and selecting the scenario corresponding to a generated event and executing each of the steps of the scenario according to the definition information.

### [Effects of the Invention]

According to the present invention, a workflow for automation can be easily produced.

### BRIEF DESCRIPTION OF DRAWINGS

FIG. 1 illustrates an exemplary scenario including a combination of general tasks.

FIG. 2 illustrates an exemplary scenario for a construction information obtaining step including a combination of general tasks.

FIG. 3 illustrates an exemplary scenario for a troubleshooting information obtaining step including a combination of general tasks.

FIG. 4 illustrates an exemplary scenario for a device information obtaining step including a combination of general tasks.

FIG. 5 is a diagram of exemplary general tasks.

FIG. 6 illustrates an exemplary external definition file for expressing steps with various general tasks.

FIG. 7 is a diagram of an exemplary configuration of an information processing device according to an embodiment of the invention.

FIG. 8 is a flowchart for illustrating the flow of processing carried out by the information processing device according to the embodiment.

FIG. 9 is an exemplary hardware configuration of the information processing device.

### DESCRIPTION OF EMBODIMENTS

According to the embodiment, steps in a workflow are expressed by general-purpose tasks (hereinafter simply as general tasks) and general tasks are combined to compose a scenario. The general tasks are loosely coupled and can be freely combined.

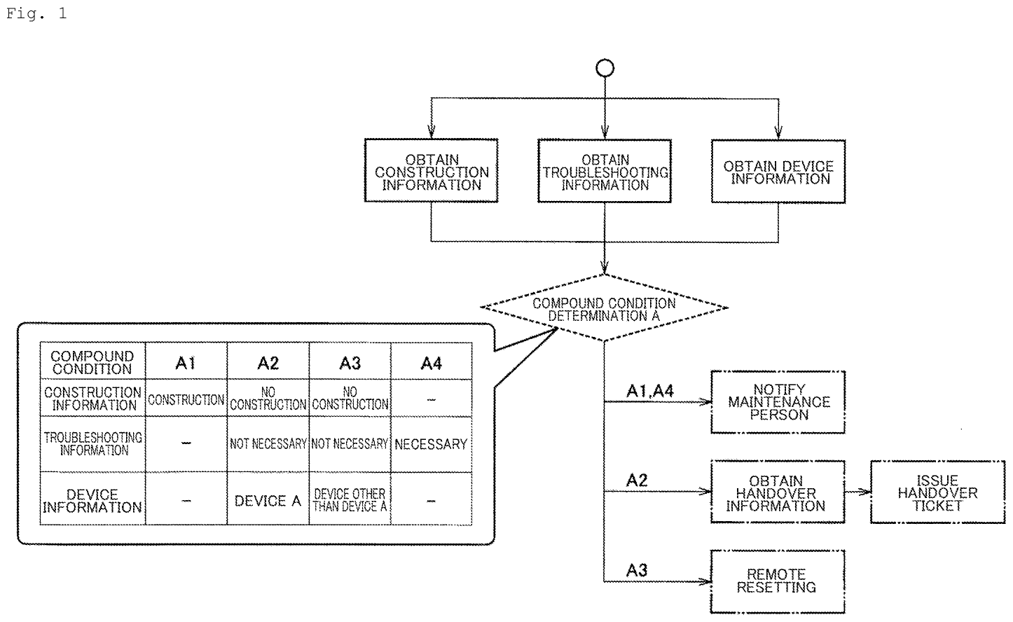

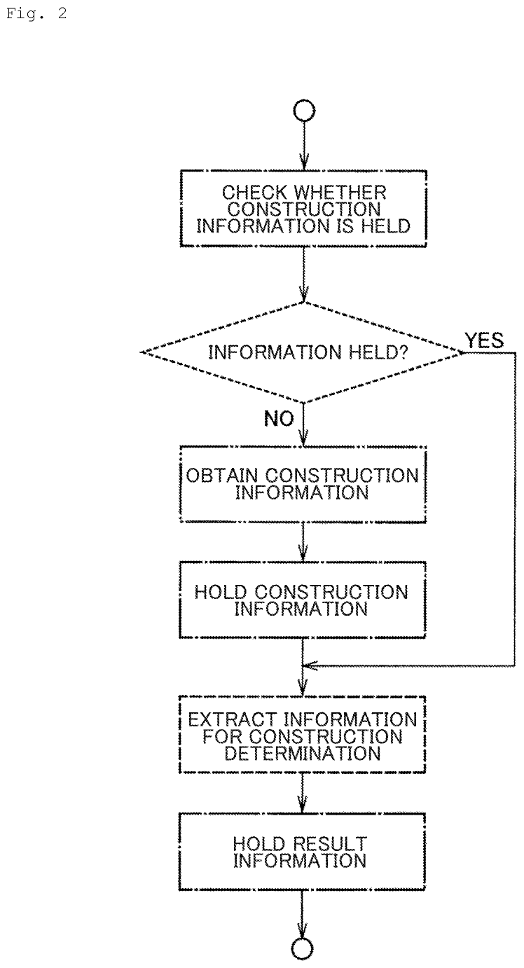

FIG. 1 illustrates an exemplary scenario including a combination of general tasks. The rectangles and the diamond drawn by the dashed lines, the single-dotted dashed lines, or the double-dotted dashed lines indicate the steps expressed by the general tasks. The type of the general task differs depending on the line type and shape. The types of general tasks will be described below. A construction information obtaining step, a troubleshooting information obtaining step, and a device information obtaining step are each represented as a combination of general tasks as shown in FIGS. 2 to 4. The scenarios are held by the information processing device which will be described. The information processing device holds multiple scenarios and selects and executes a scenario corresponding to a received event. In the scenario shown in FIG. 1, when a failure alarm is received, construction information, troubleshooting information, and device information are obtained in the construction information obtaining step, the troubleshooting information obtaining step, and the device information obtaining step.

In the construction information obtaining step shown in FIG. 2, it is determined whether the information processing device holds construction information, and if the device does not hold the construction information, construction information is obtained from an external system and held. Then, the information processing device extracts information necessary for determination in a succeeding stage and holds the processing result.

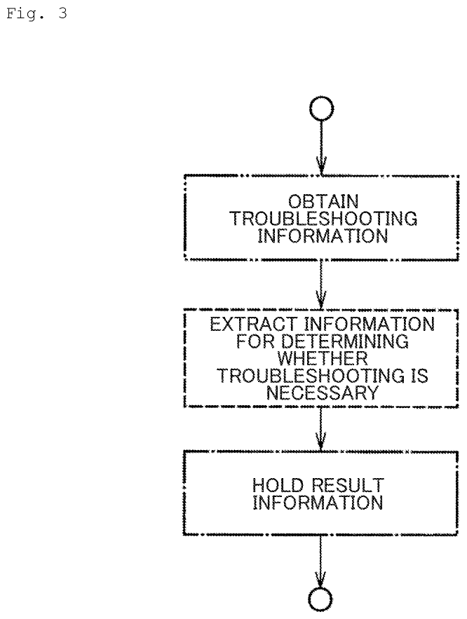

In the troubleshooting information obtaining step shown in FIG. 3, the information processing device obtains troubleshooting information from an external system, extracts information necessary for the succeeding determination stage, and holds the processing result.

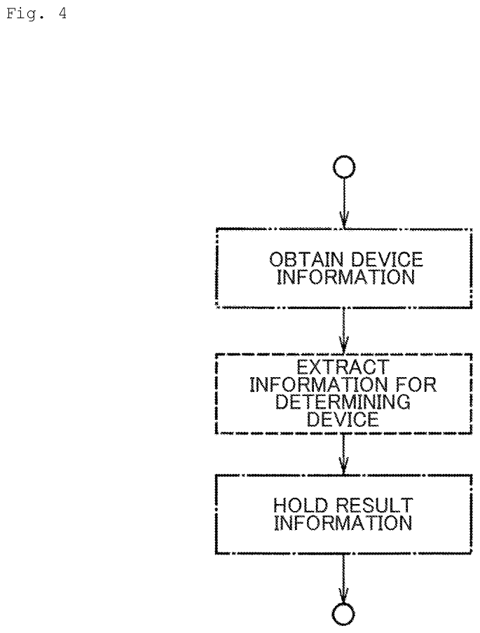

In the device information obtaining step in FIG. 4, the information processing device obtains device information from the external system, extracts information necessary for the succeeding determination stage, and holds the processing result.

In the compound condition determination A shown in FIG. 1, using the processing results from the above three steps, the information processing device determines branch destinations A1 to A4 according to a table having a list of compound conditions for the branch destinations A1 to A4. Specifically, as shown in FIG. 1, if the construction information indicates the presence of a construction, the process proceeds to the branch destination A1, and if the troubleshooting information indicates that troubleshooting is necessary, the process proceeds to the branch destination A4. If the construction information does not indicate the presence of a construction, the troubleshooting information indicates that troubleshooting is not necessary, and the device information indicates the device A, the process proceeds to the branch destination A2, and if the device information is not about the device A, the process proceeds to the branch destination A3.

At the branch destinations A1 and A4, the maintenance person is notified. At the branch destination A2, handover information is obtained and a ticket for the handover work is issued. At the branch destination A3, remote resetting is performed. In other words, if there is a failure alarm caused by a construction, or if a failure is in the process of troubleshooting, the maintenance person is notified of the state, and if the device cannot be reset remotely, the work is handed over, while if the device can be reset remotely, remote resetting is performed.

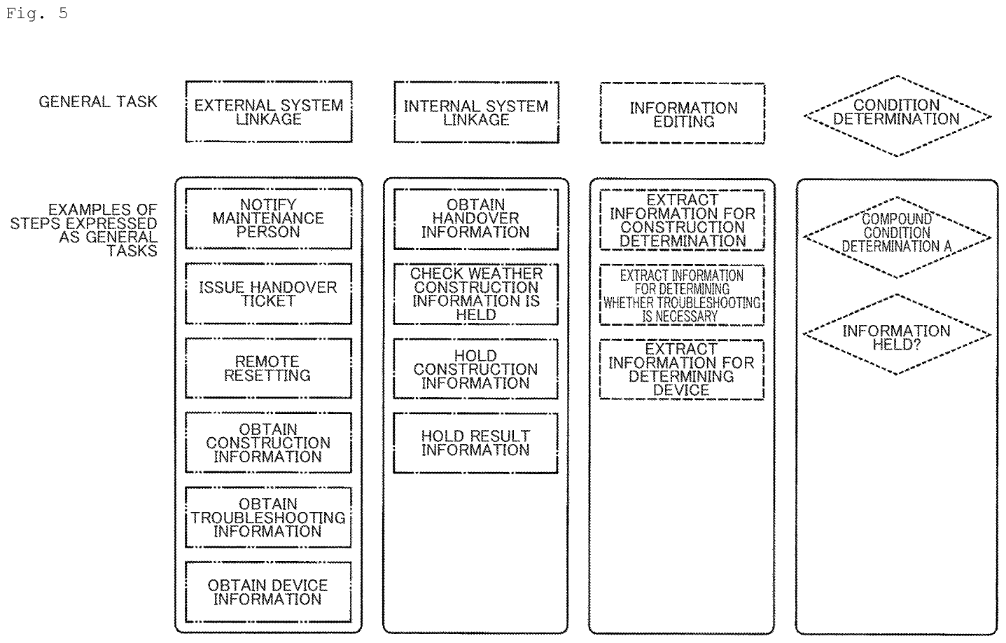

According to the embodiment, as shown in FIG. 5, the steps in the workflow are represented by four general tasks, i.e., an external system linkage, an internal system linkage, information editing, and condition determination. The external system linkage is a task for expressing a step which uses an external system. For example, the external system linkage may express the step of notifying the maintenance person, the step of issuing a handover ticket, or the remotely resetting step as well as the construction information obtaining step, the troubleshooting information obtaining step, or the step of obtaining device information from the external system. The internal system linkage is a task for expressing a step which uses any of functions in the information processing device. For example, the linkage may express the step of storing information obtained or received from an external system in a database in the information processing device or the step of obtaining information from the database in the information processing device. The information editing is a task for expressing the step of operating information managed by the information processing device. For example, the task may express the step of rewriting information stored in the database in the information processing device or the step of adding arbitrary information. The condition determination is a task for expressing the step of controlling the processing flow according to conditions. According to the embodiment, multiple branches can be set by compounding multiple conditions rather than according to only one condition. In FIGS. 1 to 5, the external system linkage task is illustrated by the double-dotted dashed line, the internal system linkage task by the single-dotted dashed line, the information editing task by the dashed line, and the condition determination tasks in a diamond shape.

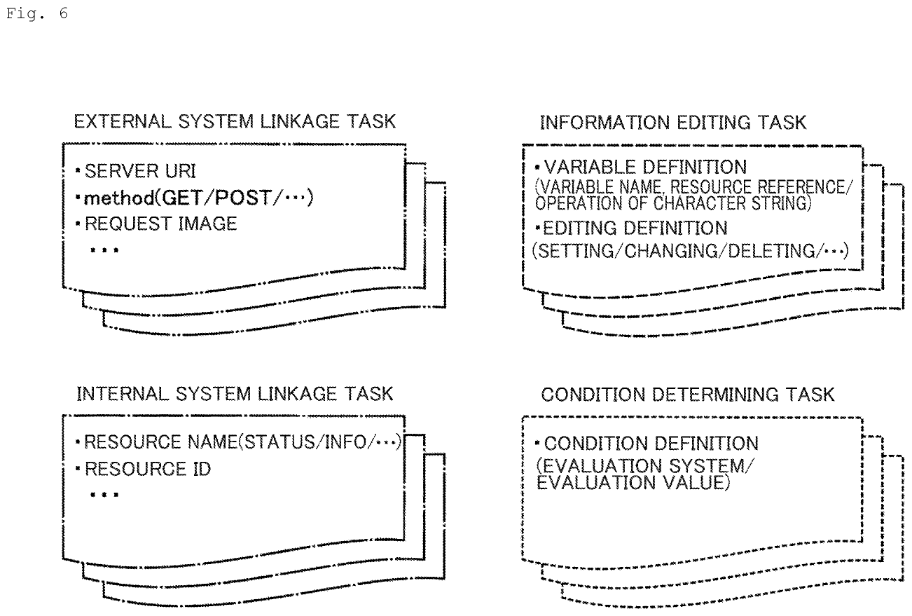

The processing (data operation such as extraction, formatting, and processing) in each step is defined by an external definition file of abstracted setting items in a form for each of general tasks as shown in FIG. 6. For example, the external definition file of the external system linkage task includes information for using an external system, the external definition file of the internal system linkage task includes information for using functions in the information processing device, the external definition file of the information editing task includes information to be edited and the information of the edited content, and the external definition file of the condition determination task includes a description of conditions.

The information processing device refers to an external definition file which defines each step using the function for processing general tasks and executes the processing according to the external definition file. In other words, the information processing device converts the values of abstracted setting items on the external definition file into a data format accessible to various databases and various kinds of definition information and executes obtaining, updating, and deletion of various kinds of information. In this way, readability can be maintained by hiding complex settings, such as the data structure of the databases in the external system and the information processing device, data distribution consistency can be maintained between steps, and the user of the general tasks do not need advanced skills.

As described above, according to the embodiment, a workflow is expressed by combining steps using general tasks, and detailed settings for processing in each of the steps are defined in an external definition file, so that the sequential workflow and the processing in each of the steps are managed separately, which makes it easier to create workflows (scenarios).

The number of general tasks is not limited to four or the number is not limited to those shown in FIG. 5. It is only necessary to prepare appropriate general tasks according to the work field. According to the embodiment, troubleshooting tasks in a communication network are described by way of illustration, but the kind of work to which the present invention is applicable is not limited to the troubleshooting work.

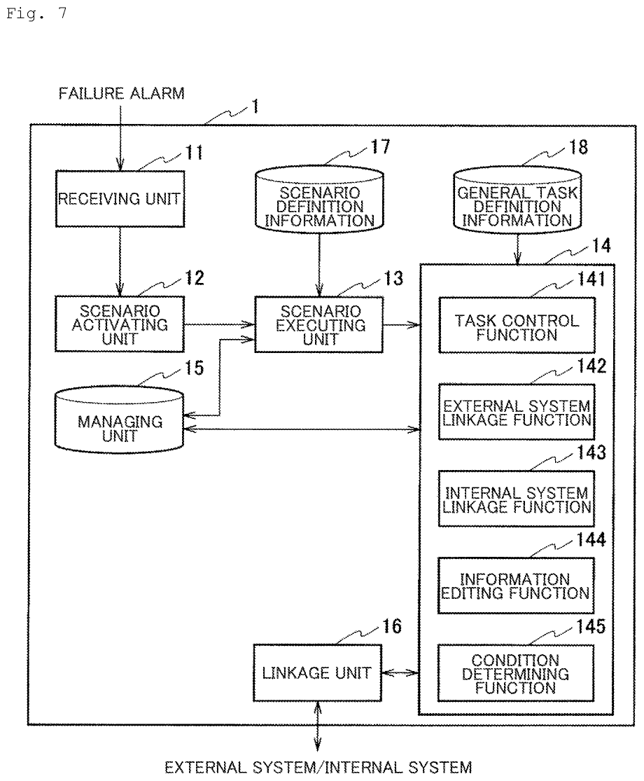

Now, referring to FIG. 7, the information processing device 1 according to the embodiment will be described. The information processing device 1 has a receiving unit 11, a scenario activating unit 12, a scenario executing unit 13, a general task executing unit 14, a managing unit 15, a linkage unit 16, scenario definition information 17, and general task definition information 18. The information processing device 1 holds scenarios each including a combination of steps expressed using general tasks. Upon receiving a failure alarm from a monitoring target, the information processing device 1 executes a workflow according to a scenario corresponding to the failure alarm.

The receiving unit 11 receives a failure alarm (event) and passes the received failure alarm to the scenario activating unit 12. If multiple failure alarms are received, the receiving unit 11 may select a failure alarm which is a root cause and pass the alarm to the scenario activating unit 12.

In response to the failure alarm, the scenario activating unit 12 selects a corresponding scenario and calls the scenario executing unit 13.

The scenario executing unit 13 obtains the corresponding scenario from the scenario definition information 17 and causes the general task executing unit 14 to execute each of the steps in the scenario. The scenario executing unit 13 may include a commercially available workflow engine.

The general task executing unit 14 reads the external definition file of a step to be executed in response to an instruction from the scenario executing unit 13 and executes the step according to the external definition file. The general task executing unit 14 in FIG. 7 has a task control function 141, an external system linkage function 142, an internal system linkage function 143, an information editing function 144, and a condition determining function 145.

The task control function 141 reads the external definition file of the step to be executed from the general task definition information 18 and operates or stops the external system linkage function 142, the internal system linkage function 143, the information editing function 144, and the condition determining function 145 according to the external definition file.

The external system linkage function 142, the internal system linkage function 143, the information editing function 144, and the condition determining function 145 respectively execute the processing of general tasks for the external system linkage, the internal system linkage, the information editing, and the condition determination according to the external definition file.

The managing unit 15 includes various databases and various kinds of definition information and manages information necessary for scenario execution and task execution. For example, the managing unit 15 manages the scenario execution state, scenario thread management information, event monitoring information, and event definition information referred to by the scenario executing unit 13 and manages task resources, task processing information, and server/account information referred to by the general task executing unit 14. As a specific example, in the construction information obtaining step, the troubleshooting information obtaining step, and the device information obtaining step in FIGS. 2 to 4, a construction information obtaining task, a troubleshooting information obtaining task, and a device information obtaining task obtain a group of information including information to be used in the compound condition determining A task in the succeeding stage from an external system, a construction determination information extracting task, a troubleshooting necessity determination information extracting task, and a device determining information extracting task extract information to be used in the compound condition determining A task in the succeeding stage from the group of information, a result information holding task holds the extracted information at the managing unit 15, and the compound condition determining A task carries out determination processing by referring to the information held in the managing unit 15.

In the external definition file, the various databases and various definition information that make up the managing unit 15 are abstracted as setting items, their values are defined, and data operation contents such as setting/changing/deleting are specified. The values of the abstracted setting items are converted by the task executing unit 14 into a data format accessible to the various databases and various definition information.

The linkage unit 16 calls the interface with the external system or the internal system in response to an instruction from the general task executing unit 14.

The scenario definition information 17 holds a scenario including a combination of steps expressed using multiple types of general tasks.

The general task definition information 18 holds an external definition file which defines processing in each of the steps expressed using general tasks.

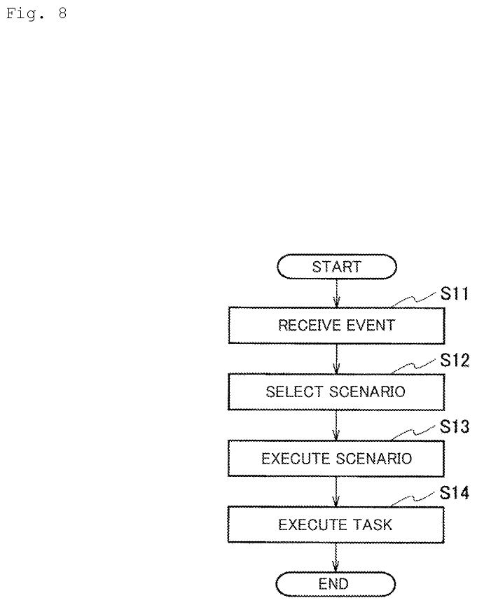

Now, the operation of the information processing device 1 according to the embodiment will be described with reference to the flowchart in FIG. 8.

In step S11, the information processing device 1 receives an event.

In step S12, the information processing device 1 selects a scenario corresponding to the received event.

In step S13, the information processing device 1 starts to execute the scenario.

In step S14, the information processing device 1 executes steps which compose the scenario according to the external definition file.

As described above, the information processing device 1 according to the embodiment has the scenario definition information 17 that holds a scenario including a combination of steps in a workflow expressed using multiple types of general tasks, the general task definition information 18 which holds an external definition file which defines processing in each of the steps, and the general task executing unit 14 which executes a step according to an external definition file corresponding to the step, and the scenario executing unit 13 which selects a scenario according to a received failure alarm and causes the general task executing unit 14 to execute each of the steps according to the scenario. As a result, the information processing device 1 according to the embodiment can express each of the steps in the workflow using general tasks and can easily create a workflow by combining the steps. The information processing device 1 according to the embodiment can also easily create a workflow by managing a series of operation flows and processing in the steps separately.

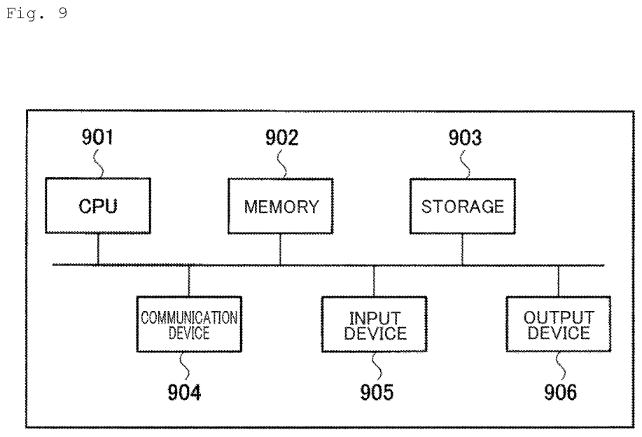

For example, the information processing device 1 described above may be a general-purpose computer system including a central processing unit (CPU) 901, a memory 902, a storage 903, a communication device 904, an input device 905, and an output device 906 for example as shown in FIG. 9. In the computer system, the information processing device 1 is implemented as the CPU 901 executes a prescribed program loaded on the memory 902. The program can be recorded for example on a computer-readable recording medium such as a magnetic disk, an optical disk, or a semiconductor memory, or can be distributed over a network.

### REFERENCE SIGNS LIST

1 Information processing device
11 Receiving unit
12 Scenario activating unit
13 Scenario executing unit
14 General task executing unit
15 Managing unit
16 Linkage unit
17 Scenario definition information
18 General task definition information

1. An information processing device for executing a workflow, the information processing device comprising a processor configured to execute instructions that cause the information processing device to perform operations comprising:
holding a scenario including a combination of steps in the workflow expressed using multiple kinds of general tasks;
holding definition information which defines processing in each of the steps in a form for each of the general tasks;
executing the step according to the definition information corresponding to the step; and
selecting the scenario corresponding to a generated event and executing each of the steps according to the scenario.

2. The information processing device according to claim 1, wherein
the definition information includes an abstracted setting item, and
the instructions cause the information processing device to perform operations including converting the value of the setting item into a form accessible to data to be operated.

3. The information processing device according to claim 1, wherein the general tasks include an external system linkage task to link with an external system, an internal system linkage task to link with a function in the information processing device, an information editing task to operate information managed by the information processing device, and a condition determining task to branch processing according to a condition.

4. The information processing device according to claim 3, wherein the information condition determining task determines a plurality of branch destinations on the basis of a plurality of conditions.

5. An information processing method for executing a workflow, the method comprising:
holding a scenario including a combination of steps in the workflow expressed using multiple of kinds of general tasks;
holding definition information which defines processing in each of the steps; and
selecting the scenario corresponding to a generated event and executing each of the steps of the scenario according to the definition information.

6. A non-transitory computer-readable medium storing a program that, when executed by a computer, causes the computer to perform operations comprising:
holding a scenario including a combination of steps in a workflow expressed using multiple of kinds of general tasks;
holding definition information which defines processing in each of the steps; and
selecting the scenario corresponding to a generated event and executing each of the steps of the scenario according to the definition information.
